(19) United States
(12) Patent Application Publication
(10) Pub. No.: US 2007/0219907 A1
(43) Pub. Date: Sep. 20, 2007

(54) ONE-CLICK DIGITAL PACKAGE PURCHASE AND ARCHIVE

(76) Inventor: BRIAN C. BALLARD, Seattle, WA (US)

Correspondence Address: FITZPATRICK CELLA HARPER & SCINTO, 30 ROCKEFELLER PLAZA, NEW YORK, NY, 10112, US

(21) Appl. No.: 11/276,820

(22) Filed: Mar. 15, 2006

(51) Int. Cl. H04L 9/00

(52) U.S. Cl. 705/51

(57) ABSTRACT

A method for providing a package of digital items to a user is described. The digital items are packaged into a package, and the package is encrypted and wrapped in a digital rights management system. A purchase request is received from the user requesting purchase of the package. The package is transmitted to the user for decryption and storage of the package directly onto a portable medium upon receipt by the user. The purchase request is received and the package is transmitted based on web services.

### BACKGROUND OF THE INVENTION

1. Field of the Invention

The present invention relates generally to transactions involving digital goods, and relates more particularly to purchase of a package of digital goods, such as an album of digital songs, a season of digital television shows, or chapters of an audio book, delivery of the purchased goods, and archiving of the purchased goods directly to portable media, such as a portable music player.

2. Related Art

As consumers gain faster and cheaper access to the internet, demand for digital goods that are purchased and delivered via the internet has steadily increased. As more digital goods are digitally distributed to consumers, the number of transactions and data files a consumer must manage has increased, thus increasing the burden on the consumer.

In addition, offers for digital goods often include packages of more than one item (e.g. albums contain several songs, DVDs contain several episodes, episodes contain several scenes, book collections contain several books, books contain several chapters, package offers contain more than one of the same or different items). However, although methods of delivery of packaged digital goods are known, traditional ways of selling packages of digital goods can be difficult for consumers who wish to store and use the digital goods on portable media or devices.

In particular, once a package of digital goods is purchased and delivered to the user's computer hard drive, the user generally must take additional steps to archive those goods to a portable medium (for example, a portable music player).

### BRIEF DESCRIPTION OF THE INVENTION

The present invention addresses the problems identified above by providing a system, method and computer program for enabling an end-user to purchase a package of digital goods without purchasing each of the individual constituent items through separate actions, and without the need to take additional actions to receive delivery of (“download”) the individual goods. In addition, the present invention addresses the problems identified above by using web services to allow the delivery of digital goods directly to a portable medium.

In accordance with one aspect of the present invention, a package of digital items is provided to a user. Digital items are packaged into a package, and the package is encrypted and wrapped in a digital rights management system. A purchase request is received from the user requesting purchase of the package, and the package is transmitted to the user for decryption and storage of the package directly onto a portable medium upon receipt by the user. Receiving the purchase request and transmitting the package are based on web services.

In accordance with another aspect of the present invention, the digital items are selected from the group consisting of digital songs, digital video files, and digital books.

In accordance with yet another aspect of the present invention, the portable medium is a portable music player.

In accordance with still another aspect of the present invention, a price for the package is determined independently of the prices of the digital items.

In accordance with a further aspect of the present invention, the user is restricted from adding or subtracting digital items from the package prior to transmittal of the package to the user.

In accordance with yet another aspect of the present invention, the digital items are selected to be included in the package, and each digital item is selected based on commonality of product identification codes between the digital item and the package.

In one advantage of the present invention, the use of web services for the transfer of messages and data allows for expanded capability and ease of implementation.

Another advantage of the present invention is that packages of goods can be delivered directly to archival media without additional action by the consumer, rather than requiring delivery to an initial storage medium (for example, a computer hard drive) before a consumer can archive the digital goods to other media.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings. In the drawings, like reference numbers indicate identical or functionally similar elements.

FIG. 1 is a system block diagram illustrating systematically and functionally an exemplary environment in which an embodiment of the present invention can operate.

FIG. 2 is a flowchart of a method according to one embodiment of the present invention.

### DETAILED DESCRIPTION

The present invention is described in more detail herein in terms of several exemplary implementations. This reference to specific implementations is for convenience only and is not intended to limit the application of the present invention.

Generally, the present invention is directed to a system, method and computer program product for using web services for delivery of a package of digital items to a user. Rather than require delivery to an initial storage medium (for example, a computer hard drive) before a consumer can archive the digital goods to other media, packages of goods are delivered directly to portable media without additional action by the consumer.

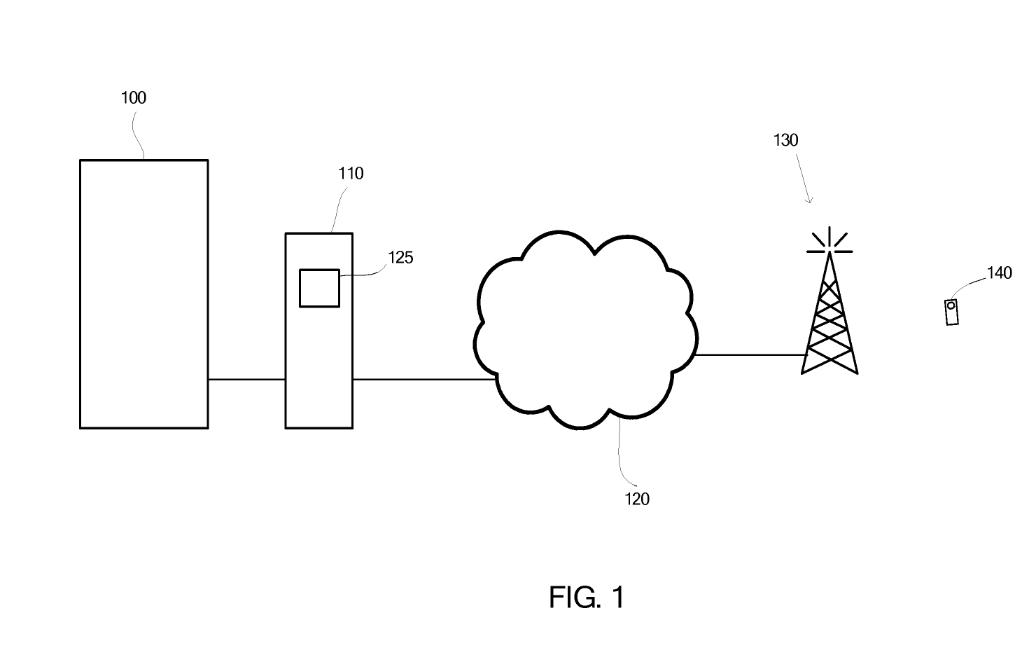

FIG. 1 is an illustrative environment in which the present invention operates. An online digital content provider offers digital items, such as digital songs, for purchase and download. A digital content repository 100 stores the digital items. A server 110 operated by the online digital content provider is connected to the digital content repository 100 and internet 120. Server 110 operates a web services platform 125 for the delivery of packages of digital items to consumers, as explained in more detail below.

A consumer operates a portable medium 140, such as a portable music player, which is connected to internet 120 via hotspot 130. Portable medium 140 allows selection and downloading of albums and songs from digital content repository 100 through web services platform 125.

The online digital content provider offers packages of digital items, such as albums that contain a plurality of digital songs, to consumers. For example, the online digital content provider can operate a website through server 110, and offer packages for purchase on the website.

In one representative embodiment, the online digital content provider defines the albums, which are offered for sale on the website. For example, an album can be defined as a group of digital songs on digital content repository 100 that are identified by a common universal product code (“UPC”) or stock keeping unit (“SKU”) number. In particular, the group of songs can correspond to either a physical compact disk (CD) album with the same SKU, or a digital album song listing specified by a music producer and assigned its own SKU by the music producer. Albums are only available for sale if all the digital songs are available in digital content repository 100. All digital songs on albums available for sale will have a corresponding album sale right enabled.

The online digital content provider ensures that album definitions are periodically updated, for example, with current prices for each album, such as a music producer price and an online digital content provider price. The music producer price for an album can either be specifically provided by the music producer or, when not specified by the music producer, it can be calculated based on the sum of the individual prices of the album songs.

In addition, the online digital content provider can define parameters for a sale, which can be used to create offers for album sales. For example, the online digital content provider could restrict the sale of individual songs, instead requiring that all of the songs on an album will be available only through sale of the album. In addition, the online digital content provider could require that consumers are prevented from adding or subtracting from an album song listing when purchasing an album.

In addition, server 110 can include information on the pricing of albums and songs. For example, every album in digital content repository 100 (and thus every song on the album) has an album Label Price (which corresponds to the price paid by the online digital content provider for the album) and a wholesale price associated with the album. Each album further has a flag that indicates if the album is available for album sales at an album price. The album price may be the same as the total of the individual song prices. Likewise, every song in digital content repository 100 has a Label Price (which corresponds to the price paid by the online digital content provider for the song) and a wholesale price associated with it. Further, each song has a flag that indicates if the song is available for individual song sales. Individual songs and albums have only one Label Price and one wholesale price at any time.

The rights for purchased album downloads would not differ from the rights for purchased a la carte permanent downloads. For example, the permanent content is associated with licenses that do not expire and unlimited plays. Purchased permanent album downloads are encrypted and wrapped in a digital rights management (DRM) scheme.

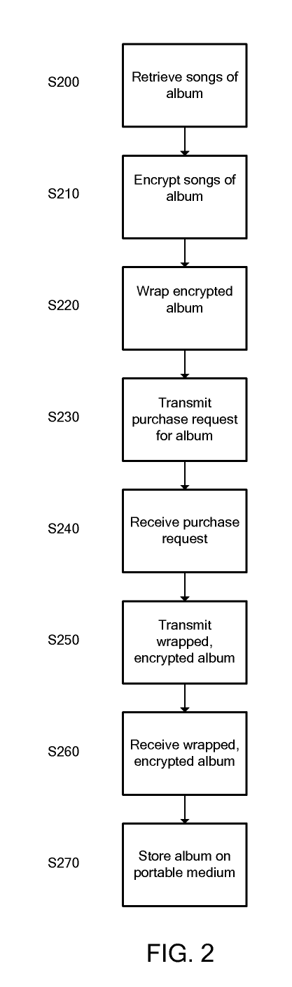

FIG. 2 is a flowchart illustrating a method according to one illustrative embodiment of providing a package of digital items to a consumer via web services. Packages are created by retrieving (S200) the corresponding songs from digital content repository 100, encrypting (S210) the songs of the requested album, and wrapping (S220) the encrypted album in a digital rights management (“DRM”) system. After viewing the albums offered for sale on the website, the consumer transmits (S230) a purchase request to server 110 via internet 120. Web services platform 125 allows portable medium 140 to communicate with server 110. Server 110 receives (S240) the purchase request, and processes the request.

Server 110 transmits (S250) the wrapped, encrypted album to portable medium 140. Portable medium 140 receives (S260) the wrapped, encrypted album, which is then stored (S260).

Web services can also be used to provide added functionality. For example, web services can be used to provide portable medium 140 with album information. In addition, web services can be used to issue purchased permanent album licenses, for example, by causing the system to issue the client the permanent download licenses for the available album tracks.

The foregoing embodiments are merely illustrative of the possible implementations of the present invention and, accordingly, do not limit the present invention. Rather, alternate systems for implementation will be apparent to those of ordinary skill in the relevant art. In particularly, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any conventional programming or scripting language known in the art including as possibilities C, C++, Java, COBOL, assembler, PERL and XML, with the various algorithms being implemented with any combination of data structures, objects, processes, routines or other programming elements. Further, it should be noted that the present invention may employ any number of conventional techniques for data transmission, signaling, data processing, network control, encryption and the like.

In addition, the exemplary networks disclosed herein may include any system for exchanging data or transacting business, such as the Internet, an intranet, an extranet, WAN, LAN, satellite communications, and the like. It is noted that the network may be implemented as other types of networks, such as an interactive television network (ITN). Further still, the terms “Internet” or “network” include the Internet itself, any replacement, competitor or successor to the Internet, or any public or private inter-network, intranet or extranet based upon either open or proprietary protocols. Moreover, a variety of conventional communications media and protocols may be used for data links providing physical connections between the various system components. For example, the data links may be an Internet Service Provider (ISP) configured to facilitate communications over a local loop as is typically used in connection with standard modem communication, cable modem, dish networks, ISDN, Digital Subscriber Lines (DSL), or any wireless communication media. In addition, the vendor may communicate with the system via a leased line, such as a T1, D3 line, or the like.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method for providing a package of digital items to a user, said method comprising:
packaging the digital items into a package, wherein the package is encrypted and wrapped in a digital rights management system; and
receiving a purchase request from the user requesting purchase of the package;
transmitting the package to the user for decryption and storage of the package directly onto a portable medium upon receipt by the user,
wherein the receiving the purchase request and the transmitting the package are based on web services.

2. The method of claim 1, wherein the digital items are selected from the group consisting of digital songs, digital video files, and digital books.

3. The method of claim 1, wherein the portable medium is a portable music player.

4. The method of claim 1, wherein a price for the package is determined independently of the prices of the digital items.

5. The method of claim 1, wherein the user is restricted from adding or subtracting digital items from the package prior to transmittal of the package to the user.

6. The method of claim 1, further comprising:
selecting the digital items to be included in the package, wherein each digital item is selected based on commonality of product identification codes between the digital item and the package.

7. A method of receiving a package of digital items, the method comprising:
determining an portable medium for storing the package;
sending a purchase request for purchase of the package to a vendor via web services;
receiving the package from the vendor, wherein the package is encrypted and wrapped in a digital rights management system; and
storing the package, wherein the digital files are stored directly on the portable medium.

8. The method of claim 7, wherein the digital items are selected from the group consisting of digital songs, digital video files, and digital books.

9. The method of claim 7, wherein the portable medium is a portable media player.

10. The method of claim 7, wherein a user is restricted from adding or subtracting digital items from the package prior to transmittal of the package to the user.
